(19) United States
(12) Patent Application Publication
(10) Pub. No.: US 2007/0006253 A1
(43) Pub. Date: Jan. 4, 2007

(54) PARTIAL PRE-ENCRYPTION WITH NETWORK-BASED PACKET SORTING

(76) Inventors: Howard G. Pinder, Norcross, GA (US); Luis A. Rovira, Atlanta, GA (US); William B. Cooper, Duluth, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/160,572

(22) Filed: Jun. 29, 2005

(51) Int. Cl. H04N 7/173; H04N 7/167

(52) U.S. Cl. 725/31; 725/87; 380/210; 725/89

(57) ABSTRACT

Partial pre-encryption with network-based packet sorting. A video-on-demand (VOD) delivery system for delivering encrypted transport streams to incumbent and overlay set-top boxes utilizes a packet picker/duplicator for sorting selected packets from non-selected packets, duplicating the selected packets, and encrypting one of the pair of duplicated selected packets according to an incumbent encryption scheme. A VOD file server stores the transport stream from the packet picker/duplicator. A network sorter sorts the unencrypted selected packet from the non-selected packets and the encrypted selected packet. The network sorter also sorts the encrypted selected packet from the non-selected packets and encrypts the unencrypted selected packets and the non-selected packets according to an overlay encryption scheme and then sends the transport stream to an overlay set-top box. The network sorter is also responsible for combining the non-selected packets and the incumbent encrypted packets and to send the transport stream to an incumbent set-top box.

### TECHNICAL FIELD

The present invention relates to conditional access systems used to control availability of video on demand (VOD) programming in content delivery systems and, more particularly, relates to providing dual encryption to permit different proprietary set-tops to be utilized in a single cable television system.

### BACKGROUND OF THE INVENTION

Video on demand (VOD) services allow a set-top box user in a communications system, such as a cable television system, to request various media services from an operator. The requested media or presentations, such as movies, etc., are then provided to the user's set-top box. For conventional VOD systems, a VOD client running inside a set-top box issues requests using quadrature phase shift keying (QPSK) or other known methods. These requests are conveyed through a hybrid fiber-coaxial (HFC) network to a VOD file server which processes the request. The VOD server packages the requested presentation using quadrature amplitude modulation (QAM) or other known methods and transmits the requested programming back to the VOD client through the HFC network. The VOD client, upon receiving the presentation, demodulates the presentation and plays it for the set-top box user. If the set-top box contains a personal video recorder (PVR), the VOD client demodulates the presentation and saves it to a hard drive in the set-top box for future play.

The control of content is important in order to protect programming from, for example, nonpaying customers. A conventional communications system, such as a cable television system, therefore, typically applies an encryption scheme to digital television content in order to prevent unrestricted access. Once a system operator chooses an encryption scheme, the operator installs all of the necessary headend equipment (e.g., Scientific-Atlanta's conditional access software and associated equipment). The receiving devices (e.g., set-tops) located at the subscriber's premises must be compatible with the encryption scheme in order to decrypt the content for viewing. Due to the (at least partial) proprietary nature of conditional access systems, however, an operator is prevented from installing different set-tops that do not have the proper decryption keys and decryption algorithms. If the operator wishes to install different set-tops that decrypt a different conditional access system, the operator would also have to install a second proprietary encryption system to overlay the incumbent encryption system in order to use both set-tops.

It would be to the operator's advantage to be able to select set-tops from any manufacturer and easily implement different encryption/decryption schemes in the system without totally duplicating the headend equipment and utilizing substantially extra bandwidth. For example, a portion, but not all, of the data required for full presentation of a video on demand (VOD) program is encrypted according to one encryption scheme and the remaining data is transmitted in the clear to minimize the bandwidth impact. All of the data required for the full presentation or a portion of the data can be encrypted according to a second encryption scheme. The remaining data, if any, is transmitted in the clear to minimize the bandwidth impact.

Because of the increasing number of customers utilizing VOD services, there is a continuous need for additional resources, such as storage space and bandwidth. The present invention helps to conserve resources by reducing the amount of storage space required on the VOD file server per presentation and minimizing the bandwidth needed to deliver the desired presentation to the user.

### BRIEF DESCRIPTION OF THE DRAWINGS

FIG. 1 illustrates a VOD delivery system method.

FIG. 2 illustrates a packet picker/duplicator, which is part of the VOD system.

FIG. 3 illustrates an alternate embodiment of the packet picker/duplicator of FIG. 2.

FIG. 4A illustrates a packet marked by transport scrambling control (TSC) in the packet picker/duplicator of FIG. 2.

FIG. 4B illustrates a packet marked by the continuity count in the packet picker/duplicator of FIG. 2.

FIGS. 4C-4D illustrate a packet marked by PIDs in the packet picker/duplicator of FIG. 2.

FIG. 5 illustrates a network sorter, which is part of the VOD system.

FIG. 6 illustrates an alternative embodiment of a network sorter of FIG. 5.

FIG. 7 illustrates an alternative embodiment of a network sorter of FIG. 5.

### DETAILED DESCRIPTION

The present invention will be described more fully hereinafter with reference to the accompanying drawings in which like numerals represent like elements throughout the several figures, and in which an exemplary embodiment of the invention is shown. This invention may, however, be embodied in many different forms and should not be construed as being limited to the embodiments set forth herein; rather, the embodiments are provided so that this disclosure will be thorough and complete, and will fully convey the scope of the invention to those skilled in the art. The present invention is described more fully herein below.

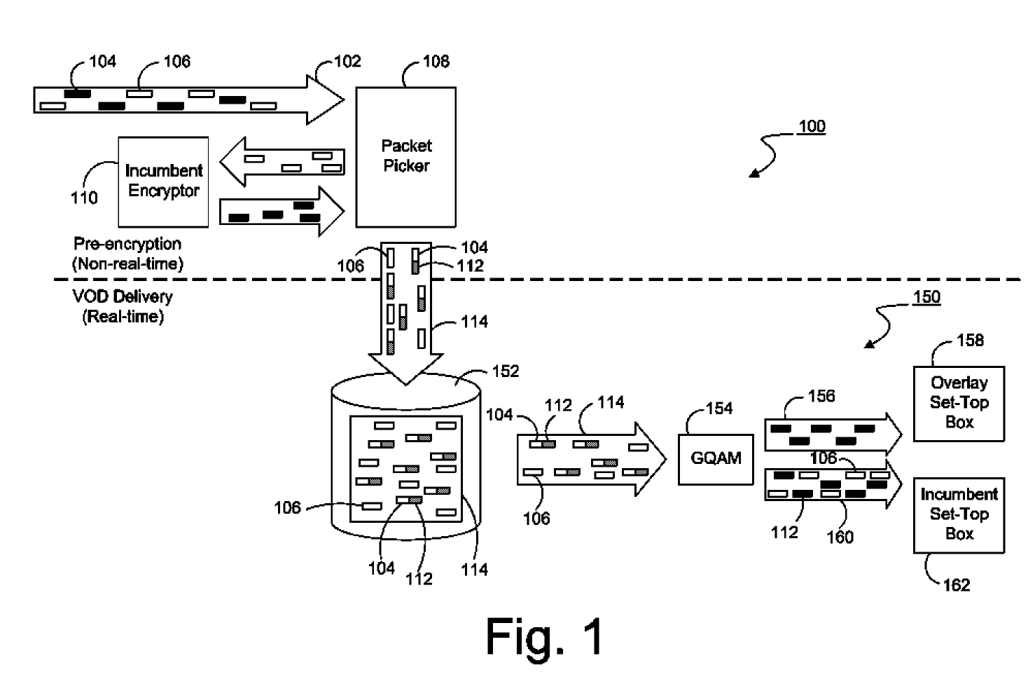

FIG. 1 illustrates a VOD delivery system including the pre-encryption phase 100 and the playout phase 150 depicted on opposite sides of a broken line used to distinguish between non-real-time and real-time. The pre-encryption phase 100 occurs in the incumbent conditional access system. A clear transport stream 102 includes several streams of unencrypted programs each including video, audio, and/or data packets. The transport stream 102 has both selected packets 104 and non-selected packets 106. Various known methods such as time slicing, M^{TH} & N packet encryption, data structure encryption, or system information (SI) encryption are used to select the portions of the transport stream as selected, or critical, packets to be encrypted. Selected packets are chosen for encryption based upon their importance to the proper decoding of the program content. For example, in MPEG content streams, selected packets are preferably packets containing higher-level headers such as picture headers, GOP headers, etc.

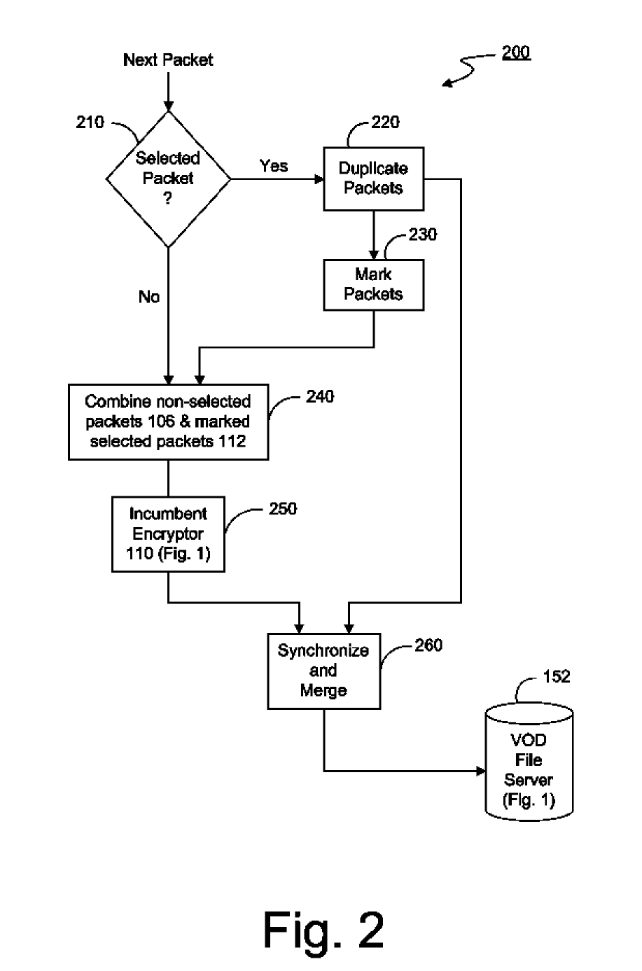

The transport stream 102 is received by a packet picker/duplicator 108 of the VOD system. FIG. 2 illustrates a process 200 for the operation of the packet picker/duplicator 108 for receiving the transport stream 102. The packet picker/duplicator 108 takes in the transport stream 102, and at decision block 210 separates out the selected packets 104 to follow the “yes” branch and the non-selected packets 106 to follow the “no” branch. In the “yes” branch, the selected packets 104 are duplicated at process block 220 to define a pair of duplicate selected packets 104. A packet 112 of the pair of selected packets 104 is marked for encryption at process block 230 for the incumbent encryption scheme.

There are at least two methods for marking the selected packet 112 to be encrypted. The first uses transport scrambling control (TSC) bits. The selected packet 112 to be encrypted will have a value other than 00. The second method for marking selected packet 112 creates a separate file that lists which particular packets are to be encrypted. However, the selected packets 112 may be marked for encryption in other ways that allow the selected packets 112 to be encrypted and distinguished from non-selected packets 106.

The marked selected packet 112 of the pair of duplicate packets 104 is then merged with the non-selected packets 106 of the “no” branch in process block 240 and sent to the incumbent encryptor 110 as shown in process block 250. The marked selected packet 112 is encrypted with the incumbent encryption scheme. The unmarked selected packet 104, the non-selected packets 106, and the encrypted selected packet 112 are then synchronized and merged as shown in step 260. FIG. 1 shows a transport stream 114 of unmarked selected packets 104, non-selected packets 106, and encrypted selected packets 112 being sent to the VOD file server 152. Therefore, rather than having two separate complete copies of the transport stream, the VOD file server 152 of the present invention instead includes only one complete copy of the transport stream 114 made up of selected packets 104 and non-selected packets 106 to be transmitted to the overlay set-top box, plus encrypted selected packets 112 which would be used in combination with the same non-selected packets 106 (used in combination with selected packets 104) to be transmitted to the incumbent set-top box.

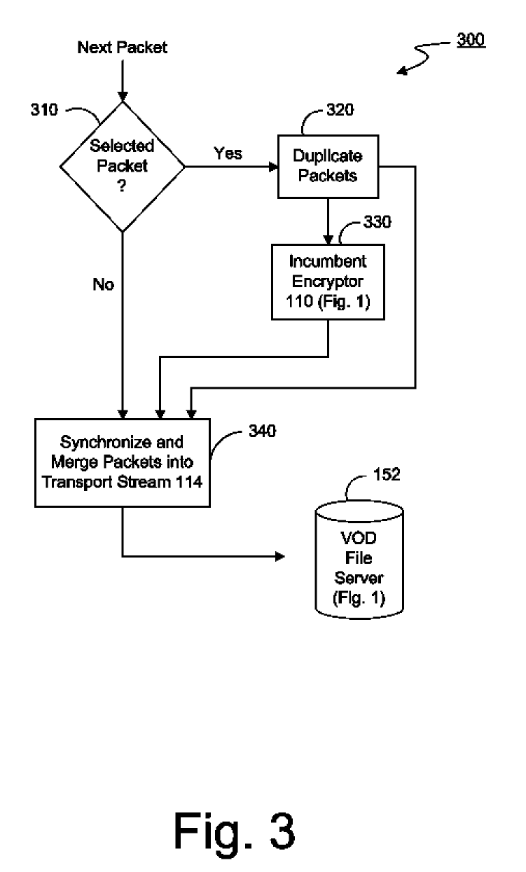

FIG. 3 illustrates an alternate embodiment of a process 300 of an alternate packet picket/duplicator. In a manner similar to the packet picker/duplicator 108, the packet picker/duplicator takes in the whole transport stream 102, and at decision block 310 separates out the selected packets 104 to follow the “yes” branch and the non-selected packets 106 to follow the “no” branch. In the “yes” branch, the selected packets 104 are duplicated at process block 320 to define a pair of duplicate packets 104. In this embodiment, however, the selected packets 112 of the pair of duplicate selected packets is not marked. Selected packets 112 are then sent to the incumbent encryptor 110 as shown in process block 330. The unencrypted selected packets 104, the encrypted selected packets 112, and the non-selected packets 106 from the “no” branch are then synchronized and merged in step 340 into transport stream 114 as shown in step 340. The transport stream 114 is sent to the VOD file server 152.

Referring back to FIG. 1, the transport stream 114 now contains clear selected packets 104, non-selected packets 106, and encrypted selected packets 112. It is desirable to know the location of each packet in the transport stream 114, especially the clear selected packets 104. There are at least four methods that will allow identification of the clear selected packets 104 within the transport stream 114.

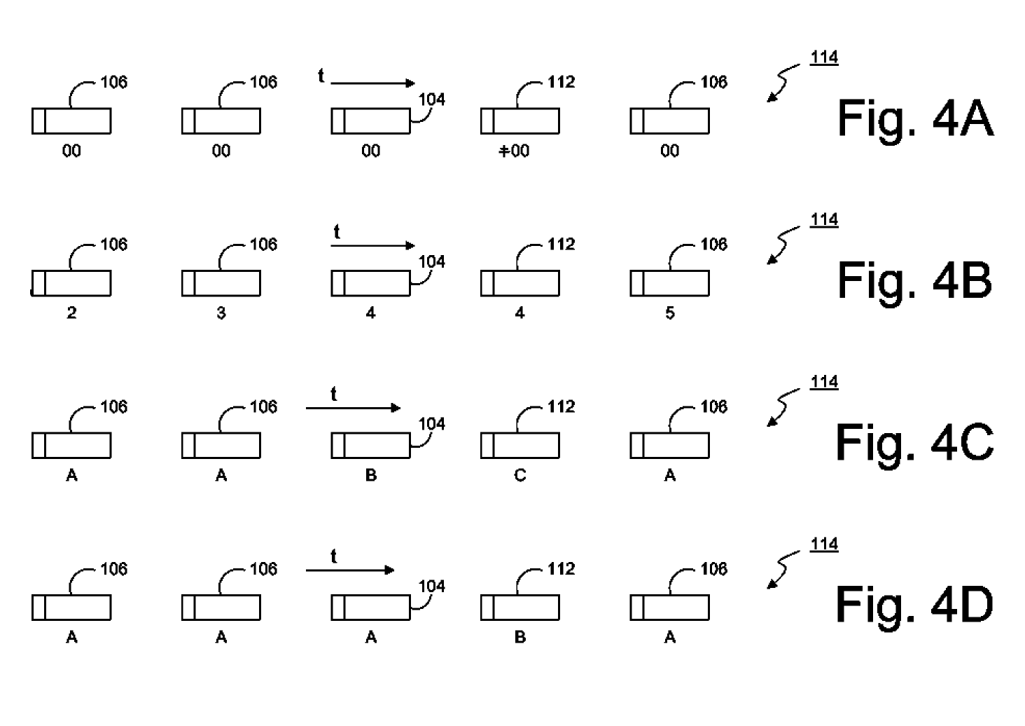

FIGS. 4A-D illustrate various methods of identifying clear selected packets 104. The stream of packets may be in any order. In these examples, the duplicate selected packets 104,112 will follow each other in sequence with the encrypted selected packet 112 coming after a corresponding selected packet 104. Also, in each of these examples, the third packet in the transport stream 114 is the clear selected packet 104 and the fourth is the encrypted selected packet 112. FIG. 4A illustrates, in particular, a method using transport scrambling control (TSC) bits. The clear packets, both selected 104 and non-selected packets 106, have a TSC of 00. However, the fourth packet, the encrypted selected packet 112, has a value of something other than 00, which occurred in the marking step 230 of FIG. 2. Therefore, the location of the clear selected packet 104 can be determined, to permit the subsequent filtering described below, because it immediately precedes the encrypted selected packet 112.

An alternate method of marking encrypted packets is illustrated in FIG. 4B. In this example, the two selected packets 104, 112 will have the same continuity count. Therefore, the location of the clear selected packet 104 can again be determined because it immediately precedes the packet without an incremented continuity count.

Another method of marking the transport packets is using packet identifiers (PIDs). The following two examples would require the synchronize and merge step 260 in FIG. 2 to also perform PID remapping. FIG. 4C illustrates five packets where the non-selected packets 106 have the same PID, such as PID A in this case. The clear selected packet 104 has PID B and the encrypted selected packet 112 has PID C. The clear selected packets 104 and encrypted selected packets 112 may be distinguished from non-selected packets 106 as well as each other because each type of packet has a different PID value.

FIG. 4D illustrates the clear packets, both selected 104 and non-selected 106, having the same PID, such as PID A. The encrypted selected packet 112 has PID B. Because only the encrypted selected packet 112 has PID B, the location of the clear selected packet 104 can be determined because it immediately precedes the encrypted selected packet 112.

Referring back to FIG. 1, the transport stream 114 can be seen leaving the packet picker/duplicator 108 now containing clear selected packets 104, non-selected packets 106, and encrypted selected packets 112. Because there is duplication of some packets, resulting in packets 104 and 112, the bandwidth is over 100%, but less than 200%, and is preferably between approximately 102% and 105% of its original size. The transport stream 114 is then sent to the VOD file server 152.

Therefore, by using partial encryption for saving content on the VOD file server 152, less material has to be saved on the VOD file server 152. Previously, two whole copies of each presentation were stored and depending on the type of set-top requesting the presentation, the appropriately encrypted presentation was sent. The current invention necessitates storage space for one copy of the transport stream made up of clear selected packets 104 and non-selected packets 106 to be transmitted to the overlay set-top box plus encrypted selected packets 112, which are encrypted duplicates of selected packets 104, that will be used in combination with non-selected packets 106 to be transmitted to the incumbent set-top box. Therefore, the VOD file server 152 has to store only a small number of duplicated packets, preferably fewer than 5% of the packets. This greatly decreases the amount of storage space required on the VOD file server 152. Also, because the VOD file server 152 has a copy of the entire presentation in the clear the VOD file server 152 is allowed to process the presentation and create indexes or separate files to enable trick mode functions (i.e. fast forward, pause, rewind).

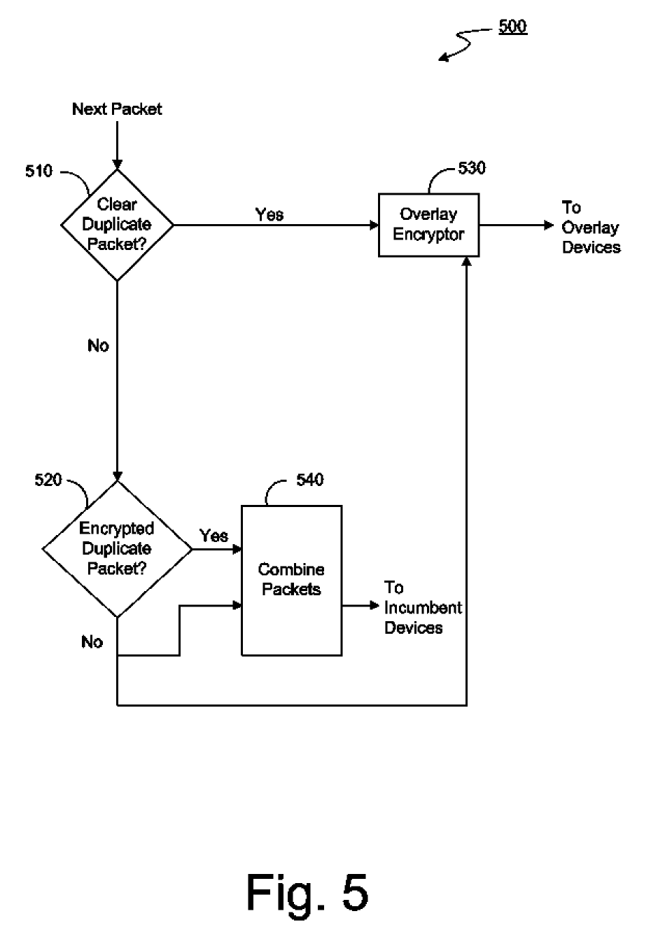

FIG. 5 illustrates the process 500 of a network sorter within the gigabit quadrature amplitude modulator (GQAM) 154, seen in FIG. 1. The network sorter is responsible for restoring the bandwidth back to 100% for each transport stream to either the incumbent or overlay set-top box. When a user chooses a particular presentation, the corresponding transport stream 114 is sent from the VOD file server 152 to the network sorter within the GQAM 154. When the transport stream 114 enters the network sorter, the clear selected packets 104 are sorted from the transport stream 114, as seen in step 510, and then sent to the “yes” branch. As explained above, process block 510 utilizes scrambling control (TSC) bits or the continuity count as described in FIGS. 4A-4B to locate the clear selected packets 104. Depending on the identifying method, the clear selected packet 104 may either immediately precede a packet have a TSC value other than 00 or immediately precede the packet without an incremented continuity count. The clear selected packets 104 and non-selected packets 106, which have been sorted in steps 510 and 520, respectively, are then combined and encrypted with the overlay encryption scheme as shown in process block 530. The transport stream 156, seen in FIG. 1, can be up to 100% encrypted with the overlay encryption scheme and the necessary bandwidth remains 100%. The transport stream 156 may be sent to an overlay set-top box 158 as shown in FIG. 1.

In step 510, the network sorter also sorts the non-selected packets 106 and the encrypted selected packets 112 from the clear selected packets 104. The non-selected packets 106 and the encrypted selected packets 112 follow the “no” branch. In step 520, the encrypted selected packets 112 are then sorted from the non-selected packets 106 and sent to the “yes” branch. The process block 540 combines the encrypted selected packets 112 and non-selected packets 106, from the “no” branch to from a transport stream 160, as seen in FIG. 1. Therefore, the transport stream 160, containing only a small percentage of incumbent scheme encrypted packets 112 and a large percentage of non-selected packets 106, is sent to an incumbent set-top box 162 in FIG. 1. The transport stream 160 is only partially encrypted and the necessary bandwidth remains 100%.

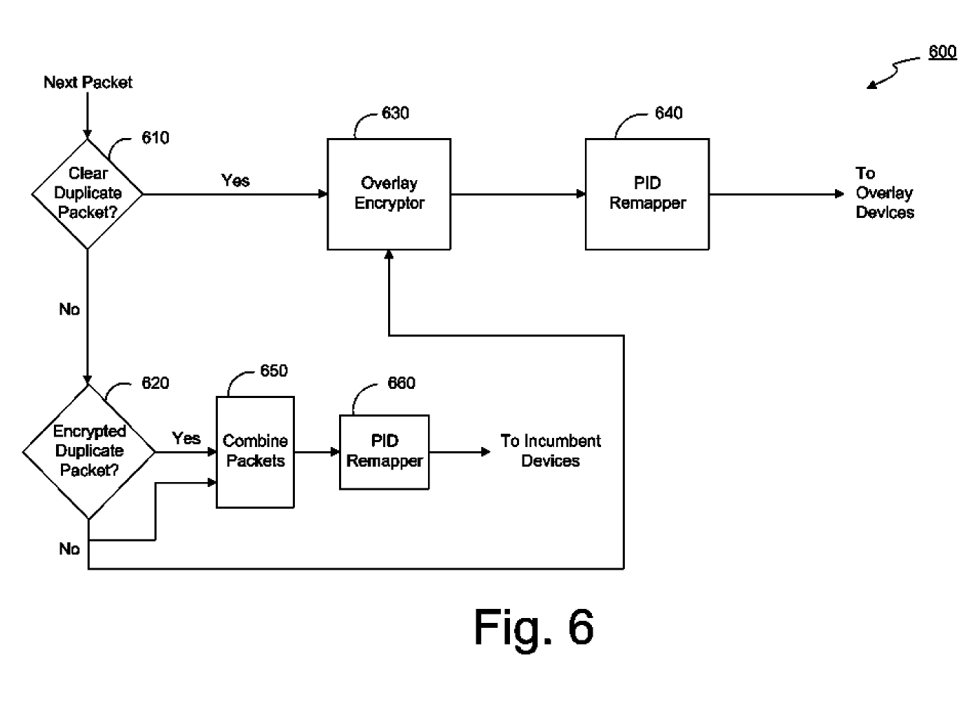

FIG. 6 illustrates an alternate embodiment of a process 600 of an alternate network sorter within the GQAM 154, as seen in FIG. 1. When a user chooses a particular presentation, the corresponding transport stream 114 is sent from the VOD file server 152 to the network sorter within the GQAM 154. When, the transport stream 114 enters the network sorter, the clear selected packets 104 are sorted from the transport stream 114, as shown in step 610, and then sent to the “yes” branch. Process block 610 utilizes the difference in PID values as described in FIG. 4C to locate the clear selected packets 104, which has a PID value of B. The clear selected packets 104 and non-selected packets 106, which have been sorted in steps 610 and 620, respectively, are then combined and encrypted with the overlay encryption scheme as shown in process block 630. The encrypted non-selected packets 106 and the encrypted selected packets 104 are then sent to a PID remapper in process block 640. This ensures that all of the packets in the stream will have the same PID value. The transport stream 156, seen in FIG. 1, can be up to 100% encrypted with the overlay encryption scheme and the necessary bandwidth remains 100%. The transport stream 156 may be sent to an overlay set-top box 158 in FIG. 1.

In step 610, the non-selected packets 106 and the encrypted selected packets 112 are sorted from the clear selected packets 104 and then follow the “no” branch. In step 620, the encrypted selected packets 112 are sorted from the non-selected packets 106 and sent to the “yes” branch. The process block 650 combines the encrypted selected packets 112 and non-selected packets 106, from the “no” branch in process block 620. The packets are then sent to a PID remapper in process block 660. This ensures that all of the packets in the stream will have the same PID value. The transport stream 160, as seen in FIG. 1, containing only a small percentage of incumbent scheme encrypted packets 112 and a large percentage of non-selected packets 106, is sent to an incumbent set-top box 162 in FIG. 1. Therefore, the transport stream 160 is only partially encrypted and the necessary bandwidth remains 100%. The network sorter, while restoring the bandwidth back to 100%, ensures all the packets in the transport stream have the same PID value.

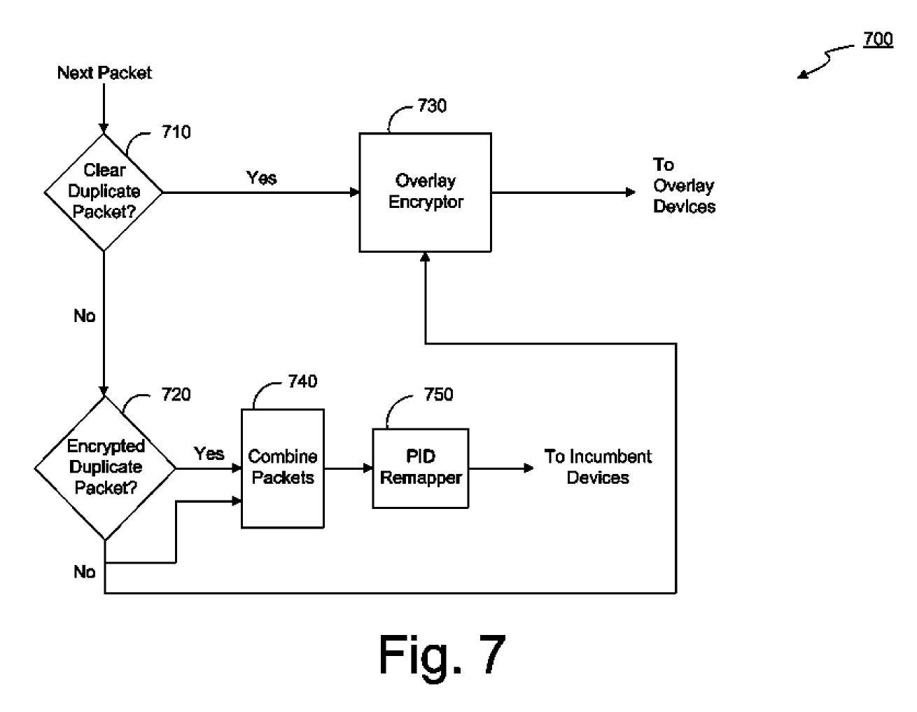

FIG. 7 illustrates an alternate embodiment of a process 700 of another alternate network sorter within the GQAM 154, as seen in FIG. 1. When a user chooses a particular presentation, the corresponding transport stream 114 is sent from the VOD file server 152 to the network sorter within the GQAM 154. When the transport stream 114 enters the network sorter, the clear selected packets 104 are sorted from the transport stream 114, as shown in step 710, and then sent to the “yes” branch. Process block 710 utilizes the difference in PID values as described in FIG. 4D to locate the clear selected packets 104. Because only the PID for the encrypted selected packet 112 has a different PID, the location of the clear selected packet 104 can be determined because it immediately precedes the encrypted selected packet 112. The clear selected packets 104 and non-selected packets 106, which have been sorted in steps 710 and 720, respectively, are then combined and encrypted with the overlay encryption scheme as shown in process block 730. Because the non-selected packets 106 and the clear selected packets 104 all had the same PID value, PID A, there is no need for PID remapping. The transport stream 156, as seen in FIG. 1, can be up to 100% encrypted with the overlay encryption scheme and the necessary bandwidth remains 100%. The transport stream 156 may be sent to an overlay set-top box 158 in FIG.

In step 710, the encrypted selected packets 112 and non-selected packets 106 are sorted from the clear selected packets 104 and then the packets follow the “no” branch. In step 720, the encrypted selected packets 112 are sorted from the non-selected packets 106 and follow the “yes” branch. The process block 740 combines the encrypted selected packets 112 and non-selected packets 106, from the “no” branch in process block 720. The packets are then sent to a PID remapper in process block 750. This ensures that all of the packets in the stream will have the same PID value. Therefore, the transport stream 160, as seen in FIG. 1, containing only a small percentage of incumbent scheme encrypted packets 112 and a large percentage of non-selected packets 106, is sent to an incumbent set-top box 162 in FIG. 1. The transport stream 160 is only partially encrypted and the necessary bandwidth remains 100%.

The combination of a packet picker/duplicator in conjunction with the network sorter in a VOD file system helps save bandwidth and allow more efficient use of the storage space in the VOD file server. The network sorter is used to determine the correct encryption needed for the requesting set-top box and to send only the corresponding encrypted presentation. This allows the necessary bandwidth to remain at 100% unlike other overlay systems. The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A video-on-demand (VOD) delivery system for delivering encrypted transport streams to incumbent and overlay set-top boxes, said VOD delivery system comprising:
a packet picker/duplicator for sorting selected packets from non-selected packets of a transport stream, duplicating at least one of said selected packets to define a pair of duplicated selected packets, and encrypting one of said pair of duplicated selected packets according to an incumbent encryption scheme;
a VOD file server for receiving and storing said transport stream from said packet picker/duplicator, wherein said transport stream comprises said non-selected packets and said pair of duplicated selected packets; and
a network sorter for sorting the other packet of said pair of duplicated selected packets from said transport stream, sorting said encrypted packet of said pair of duplicated selected packets from said non-selected packets, and encrypting said other packet of said pair of duplicated selected packets and said non-selected packets according to an overlay encryption scheme.

2. The VOD delivery system of claim 1, wherein said network sorter is further operable to transmit said transport stream of said non-selected packets encrypted according to said overlay encryption scheme and said other packet of said pair of packets also encrypted with said overlay encryption scheme to an overlay set-top box.

3. The VOD delivery system of claim 1, wherein said network sorter is further operable to combine said encrypted packet of said pair of duplicated selected packets with said non-selected packets.

4. The VOD delivery system of claim 3, wherein said network sorter is further operable to transmit said transport stream of said packets encrypted according to said incumbent encryption scheme in combination with said non-selected packets in the clear to an incumbent set-top box.

5. The packet picker/duplicator of claim 1, wherein said one packet of said pair of packets to be encrypted is marked for encryption according to said incumbent encryption scheme.

6. The packet picker/duplicator of claim 5, further comprising an incumbent encryptor to encrypt said one packet of said pair of packets.

7. The packet picker/duplicator of claim 1, further comprising an incumbent encryptor to encrypt said one packet of said pair of packets.

8. The packet picker/duplicator of claim 1, further operable to synchronize and merge said non-selected packets and said pair of duplicated selected packets into said transport stream to be received and stored at said VOD file server.

9. The packet picker/duplicator of claim 1, further operable to remap PIDs of said packets of said transport stream such that PIDS of said incumbent encrypted packets are distinguishable from said other packets of said pair of packets and said non-selected packets.

10. The packet picker/duplicator of claim 1, further operable to remap PIDs of said packets of said transport stream such that both said packets of said pair of packets are distinguishable from said non-selected packets.

11. The packet picker/duplicator of claim 10, wherein said packets of said pair of duplicated selected packets are distinguishable from each other as well as from said non-selected packets.

12. The VOD delivery system of claim 1, wherein said transport stream when stored in said VOD file server is no greater than approximately 105% of said transport stream when received at said packet picker/duplicator.

13. The VOD delivery system of claim 12, wherein said transport stream stored in said VOD file server is between approximately 102% and 105% of said transport stream when received at said packet picker/duplicator.

14. A method for encrypting transport streams in a video-on-demand (VOD) delivery system for incumbent and overlay set-top boxes, said method comprising the steps of:
sorting selected packets from non-selected packets of a transport stream in a packet picker/duplicator;
duplicating said selected packets to define a pair of duplicated selected packets in said packet picker/duplicator;
encrypting one of said pair of duplicated selected packets according to an incumbent encryption scheme;
receiving and storing said transport stream of said non-selected packets and said pair of duplicated selected packets from said packet picker/duplicator on a VOD file server;
sorting the other packet of said pair of duplicated selected packets from said transport stream in a network sorter;
sorting said encrypted packet of said pair of duplicated selected packets from said non-selected packets in said network sorter; and
encrypting said other packet of said pair of duplicated selected packets and said non-selected packets according to an overlay encryption scheme in said network sorter.

15. The method of claim 14, further comprising the step of transmitting said transport stream of said non-selected packets encrypted according to said overlay encryption scheme and said other packets of said pair of packets also encrypted according to said overlay encryption scheme to an overlay set-top box.

16. The method of claim 14, further comprising the step of combining said encrypted packet of said pair of duplicated selected packets with said non-selected packets in said network sorter.

17. The method of claim 16, further comprising the step of transmitting said transport stream of said packets encrypted according to said incumbent encryption scheme in combination with said non-selected packets in the clear to an incumbent set-top box.

18. The method of claim 14, further comprising the step of marking one packet of said pair of packets to be encrypted in said packet picker/duplicator according to said incumbent encryption scheme.

19. The method of claim 14, further comprising the step of synchronizing and merging said non-selected packets and said pair of duplicated selected packets into said transport stream.

20. The method of claim 14, further comprising the step of remapping PIDS of said packets of said transport stream such that PIDs of said incumbent encryption packets are distinguishable from said other packets of said pair of packets and said non-selected packets.

21. The method of claim 14, further comprising the step of remapping PIDS of said packets of said transport stream such that both said packets of said pair of packets are distinguishable from said non-selected packets and from each other.

22. A packet picker/duplicator of a video-on-demand (VOD) delivery system to deliver a transport stream to incumbent and overlay set-top boxes, said packet picker/duplicator adapted to sort selected packets from non-selected packets of said transport stream, duplicate at least one of said selected packets to define a pair of duplicated selected packets, and encrypt one of said pair of duplicated selected packets according to an incumbent encryption scheme.

23. The packet picker/duplicator of claim 22, wherein said one packet of said pair of packets to be encrypted is marked for encryption according to said incumbent encryption scheme.

24. The packet picker/duplicator of claim 22, further comprising an incumbent encryptor to encrypt said one packet of said pair of packets.

25. The packet picker/duplicator of claim 22, further operable to synchronize and merge said non-selected packets and said pair of duplicated selected packets into said transport stream to be received and stored at said VOD file server.

26. The packet picker/duplicator of claim 22, further operable to remap PIDs of said packets of said transport stream such that PIDS of said incumbent encrypted packets are distinguishable from said other packets of said pair of packets and said non-selected packets.

27. The packet picker/duplicator of claim 22, further operable to remap PIDs of said packets of said transport stream such that both said packets of said pair of packets are distinguishable from said non-selected packets.

28. The packet picker/duplicator of claim 22, wherein said packets of said pair of duplicated selected packets are distinguishable from each other as well as from said non-selected packets.

29. The packet picker/duplicator of claim 22, further adapted to transmit the other packet of said pair of duplicated selected packets and said non-selected packets to a VOD file server while in the clear.

30. A network sorter of a video-on-demand (VOD) delivery system to deliver a transport stream to incumbent and overlay set-top boxes, said network sorter adapted to sort an incumbent scheme encrypted packet of a pair of duplicated selected packets from a non-selected packet of said transport stream, sort the other packet of said pair of duplicated selected packets from said transport stream, and encrypt said other packet of said pair of duplicated selected packets and said non-selected packets according to an overlay encryption scheme.

31. The network sorter of claim 30, further operable to transmit said transport stream of said non-selected packets encrypted according to said overlay encryption scheme and said other packet of said pair of packets also encrypted with said overlay encryption scheme to an overlay set-top box.

32. The network sorter of claim 30, wherein said network sorter is further operable to combine said encrypted packet of said pair of duplicated selected packets with said non-selected packets.

33. The network sorter of claim 32, wherein said network sorter is further operable to transmit said transport stream of said packets encrypted according to said incumbent encryption scheme in combination with said non-selected packets in the clear to an incumbent set-top box.
